(19) United States
(12) Patent Application Publication
(10) Pub. No.: US 2003/0212833 A1
(43) Pub. Date: Nov. 13, 2003

(54) Web-based practice management system

(75) Inventors: James D. Lapp, Canton, OH (US); Jason W. Burkett, Canton, OH (US)

Correspondence Address: Daniel A. Thomson, Brouse McDowell, 500 First National Tower, Akron, OH, 44308-1471, US

(73) Assignee: DLB Innovations, Inc., Akron, OH

(21) Appl. No.: 10/437,218

(22) Filed: May 13, 2003

Related U.S. Application Data
(60) Provisional application No. 60/379,579, filed on May 13, 2002.

(51) Int. Cl. G06F 9/44

(52) U.S. Cl. 709/315

(57) ABSTRACT

A web-based application program is included that utilizes COM objects to verify security for an end-user, client, communicating to a server requesting information. The COM objects included a DRDO conversion module and a Security module work to securely allow access to data stored in a database server. The DRDO calls and receives information from the database server and converts the raw data to XML prior top transmission over the Internet.

### 1. BACKGROUND OF THE INVENTION

This application claims priority to U.S. Provisional Patent Application, Serial No. 60/379,579, entitled WEB-BASED PRACTICE MANAGEMENT APPLICATION SYSTEM, which was filed May 13, 2002. The entirety of the provisional patent application is herein incorporated by reference.

A. Field of Invention

This invention pertains to the art of methods and apparatuses for preventing unauthorized access to a web-based application program.

B. Description of the Related Art

It is known in the art to include a firewall or other security protection for use with Internet communications between computers. One such application includes the access of information for a practice management system wherein it is important to allow selective access to information on the system by authorized users.

One aspect of practice management systems includes Internet communication of confidential records where an end-user may be able to access data without authorization. Present methods prohibit the implementation of certain types of data that is available over the Internet because of the ability for individuals to “hack” into the system. What is needed is a secure way to provide a web-based application program.

### II. SUMMARY OF THE INVENTION

According to one aspect of the present invention, a new modular security module is provided that may be called from a plurality of programs to verify a users identity.

Another aspect of the present invention includes a Data Repository Data Object that can change raw data from a database into XML for transmission over the Internet.

The present invention includes a client computer and server computer that communicate over a computer network, such as the Internet. The Server houses an information server and a database server. The information server functions to assist in the sending and receiving of information over the Internet between the computers. Dynamic web pages, with scripting, may be included that control the flow of access to the database server. A conversion module, which may be a COM object, is included that make calls to database server. A security module is included that checks end-user authority for access to certain types of database information.

Still other benefits and advantages of the invention will become apparent to those skilled in the art to which it pertains upon a reading and understanding of the following detailed specification.

### III. BRIEF DESCRIPTION OF THE DRAWINGS

The invention may take physical form in certain parts and arrangement of parts, a preferred embodiment of which will be described in detail in this specification and illustrated in the accompanying drawings which form a part hereof and wherein:

FIG. 1 is a schematic representation of personal computers connected via a network.

FIG. 2 is a schematic representation of a client-server computer relationship communicating over a network utilizing an information server and a database server.

FIG. 3 is a schematic representation of a client-server computer relationship communicating over a network utilizing a Security Module and Data Repository Data Object in conjunction with an information server and a database server.

### IV. DESCRIPTION OF THE PREFERRED EMBODIMENT

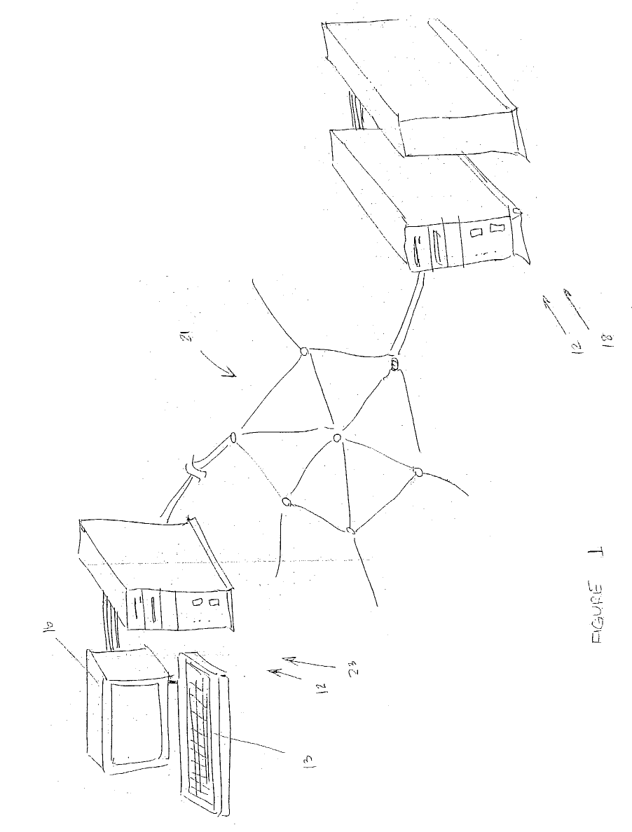

Referring now to the drawings wherein the showings are for purposes of illustrating a preferred embodiment of the invention only and not for purposes of limiting the same, FIG. 1 shows a computer system that may serve as an operating component in the environment for the invention. The computer system may include a personal computer 12, including a processing unit, a system memory, and a system bus that interconnects various system components including the system memory to the processing unit. The system bus may comprise any of several types of bus structures including a memory bus or memory controller, a peripheral bus, and a local bus using a bus architecture such as PCI, VESA, Microchannel referred to as MCA, ISA and EISA, to name a few. The system memory may also include read only memory, referred to as ROM and random access memory, referred to as RAM. A basic input/output system, referred to as BIOS, containing the basic routines that help to transfer information between elements within the personal computer 12, such as during start-up, is stored in ROM. The personal computer 12 may further includes a hard disk drive, a magnetic disk drive, e.g., to read from or write to a removable disk, and an optical disk drive, e.g., for reading a CD-ROM disk or to read from or write to other optical media. The hard disk drive, magnetic disk drive, and optical disk drive may be connected to the system bus by a hard disk drive interface, a magnetic disk drive interface, and an optical drive interface, respectively. The drives and their associated computer-readable media provide nonvolatile storage of data, data structures, computer-executable instructions (program code such as dynamic link libraries, and executable files), etc. for the personal computer. Although the description of computer-readable media above refers to a hard disk, a removable magnetic disk and a CD, it can also include other types of media that are readable by a computer, such as magnetic cassettes, flash memory cards, digital video disks, Bernoulli cartridges, and the like. It is to be understood that the aforementioned description of a computer system is exemplary and standard variations or configurations may be included without departing from the essence of the present invention.

With continued reference to FIG. 1, a number of program segments or modules may be stored in the drives and RAM, including an operating system, one or more application programs, other program modules, and program data. As is typical for personal computers, a user may enter commands and information into the personal computer through a keyboard 13 and pointing device, such as a mouse. Other input devices, not show, may include a microphone, joystick, game pad, satellite dish, scanner, or the like. These and other input devices are often connected to the processing unit through a serial port interface that is coupled to the system bus, but may be connected by other interfaces, such as a parallel port, game port or a universal serial bus, referred to as USB. However, it is noted that communication means may be enter user input into the personal computer that is chosen with sound engineering judgment. A monitor 16 or other type of display device is also connected to the system bus via an interface, such as a video adapter. In addition to the monitor, personal computers typically include other peripheral output devices, not shown, such as speakers and printers.

With continued reference to FIG. 1, software may serve as another operating component in the environment for the present invention. Software of the system of the present invention may be implemented in a network configuration in an office, business or other setting. The network of the subject invention may be the Internet, an intranet or any network chosen with sound engineering judgment as is appropriate for use with the present invention. In network installations, there may be several personal computers like the one depicted in FIG. 1. Each of the personal computers, such as PC 12, operates in a networked environment using logical connections to one or more remote computers, such as a remote computer 18. The remote computer 18 is usually a server 18, but can also be a router, a peer device or other common network node. The remote computer includes many or all of the elements described relative to the personal computer 12, although only a memory storage device has been illustrated in FIG. 1. The logical connections depicted in FIG. 1 include a local area network, referred to as LAN 21 and a wide area network, referred to as WAN 21. Such networking environments are commonplace in offices, enterprise-wide computer networks, intranets and the Internet.

With continued reference to FIG. 1, when a personal computer is used in a LAN networking environment, the personal computer 12 is connected to the local network 21 through a network interface or adapter. When used in a WAN networking environment, the personal computer 12 typically includes a modem or other means for establishing communications over the wide area network 21, such as the Internet 21. The modem, which may be internal or external, is connected to the system bus via the serial port interface or any interface chosen with sound engineering judgment. In a networked environment, program modules depicted relative to the personal computer 12, or portions of them, may be stored in the remote memory storage device. The network connections shown are examples only and other means of establishing a communications link between the computers may be used.

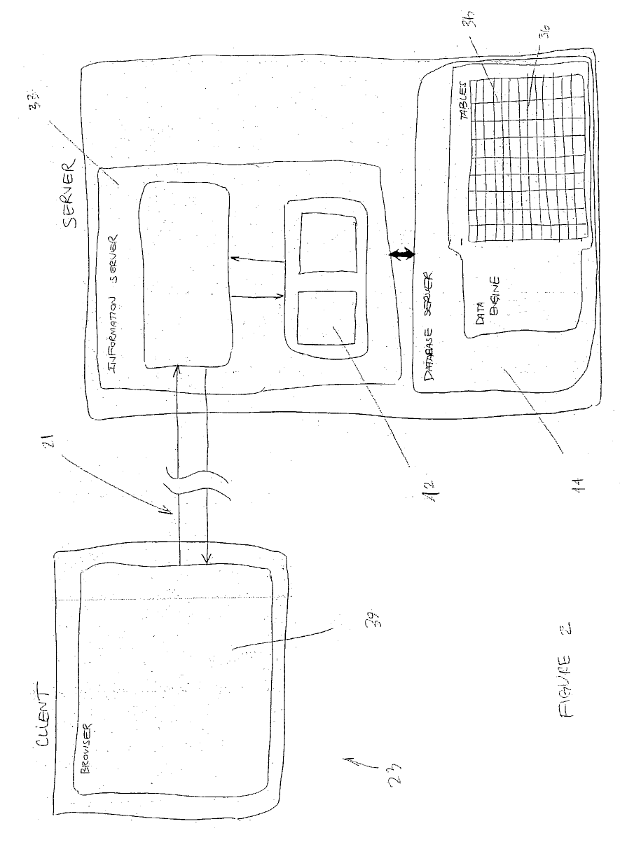

With reference now to FIG. 2, the invention of the present application may utilize one or more personal computers 12. The computers may be configured in a client-server relationship. The client and server computers may communicate via a network as described above. However, any manner of intercommunicating personal computers may be chosen with sound engineering judgment. By client-server relationship, it is meant that at least a first computer 12 functions as computer server, or Server, and a subsequent computer 12 may function as a client computer 23, or Client, that submits command requests or instructions to the Server 18. In this manner, the client computer may request information from the server computer. It is noted that the request for information may not be a request for a complete file download, which is consistent with file-sharing architectures. Rather, in response to the request by the Client, the Server computer may return specific information to be processed by the client computer. A Client 23 may therefore be defined as a requester of services and a Server computer 18 is defined as the provider of services. As previously mentioned, a single machine can be both a client and a server depending on the software configuration. In this manner, the client/server architecture reduces network traffic by providing a query response rather than total file transfer. In that the client-server relationship between computers is well known in the art, no further explanation will be offered at this time.

With reference to FIG. 2, the server computer 18 may also include an information server 33 that functions to coordinate network data being transmitted via the computer network or Internet 21. One example of such an information server 33 is Internet Information Server (IIS) by Microsoft, which may run on a personal computer 12 utilizing a Microsoft Windows operating system. It should be noted that any web information server and any operating system may be used that are compatible for use on a Server 18. The information server 33 may allow an associated end-user, using a client computer 23, to request access to send and/or retrieve data from a database 36 residing on the server computer 18, to be discussed in a subsequent paragraph. In that the client computer 23 is connected via a computer network 21, the associated user interfacing through the client computer may use a web browser 39 to request the data as mentioned above. In this manner, the browser 39 may send out a command to locate a Universal Resourcing Locator (URL) associated with the server computer 18. The request for information by the client computer 23 or client 23 may request access to execute a dynamic web page 42 stored on the Server. One such example of dynamic web pages 42 is Active Server Pages (ASP). However, it is noted that any means for executing dynamic web pages 42 may be chosen with sound engineering judgment. Therefore, in a manner well known in the art, the client 23 having a web browser 39 and network software may connect in to communicate with a server 18, via a network such as the Internet 21, for use in requesting access to execute a dynamic web pages 39, which may be viewed on the client computer 23 at a remote location from the server 18. In that the network connection, communication and transfer of data via a computer network, and/or the Internet is well known in the art, no further explanation will be offered at this point. In this way, the Client 23 may request access to or login to a web-based application program, which is distinguished from the installation of a software program onto the associated-users computer wherein information may be requested for use by the program over a network 21. In one embodiment, a web-based application program may submit requests for information, which may be periodically altered. Such information may be stored in a database 36 and may be accessible to a plurality of users, wherein the users may have varying levels of authority of access to the information.

With reference to FIG. 2, the Server 18 may include a database 39 storing schema or database manager program, referred to as a “database server” 44 that stores and sorts information in a manner well known in the art. Such examples of database managers may include Microsoft's SQL Server 44. However, any type, brand or manner of managing database information may be chosen with sound engineering judgment as is appropriate for use with present invention. The database manager 44 may store information in tables 36′ for use in a client-server application as communicated over a network 21 described above. The data may be sorted and processed via queries or any manner well known in the art of database storage, processing and management for use in viewing by an associated end-user or another program, such as a COM object, as will be discussed in a subsequent paragraph. It is noted that the database manager 44 of the subject invention may be scalable to allow for multiple user access, which may be multiple calls from a COM object, to the data stored therein. The data may be communicated to the calling entity, which may be a COM object, where the end user may have submitted requests to view selected data. It is noted at this point that the database server 44 may reside on a different server or computer than that of the calling entity, which may make requests for information on behalf of the end-user. In other words, the database server 44 and information server 33, which coordinate the communication of information over the Internet 21 or other network, may reside on different Servers. It should be noted that location of the database server 44 may not be directly accessible from within the information server. This assists in preventing unauthorized users from “hacking” into the Server 18 to discover the location of the database information, which will be discussed in a subsequent paragraph.

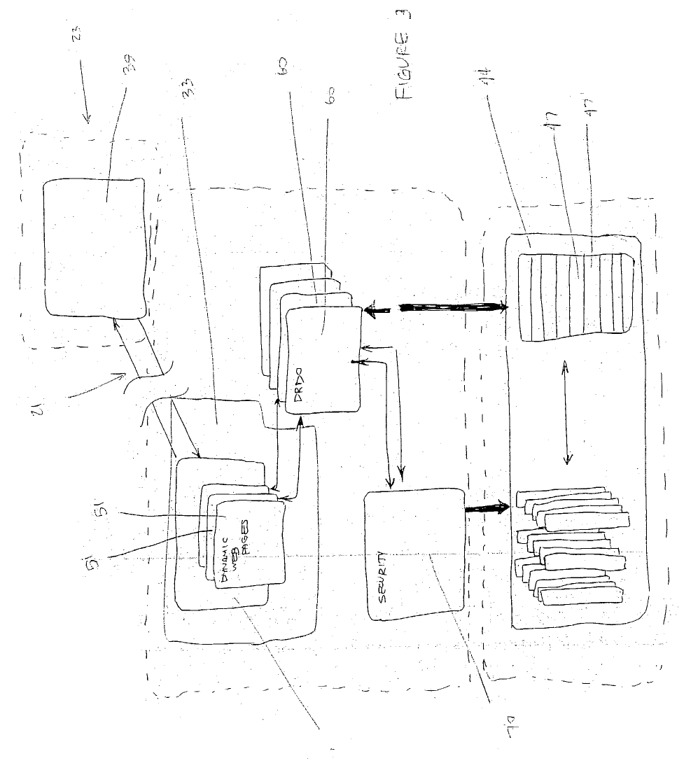

With reference to FIG. 3, in the database server 44, which may incorporate the use SQL Server, stored procedures 47 may be developed for engagement by a calling entity. Stored procedures are an assembly of organized macro-like commands that execute to perform database queries, searches, sorts and the like. The result of calling a stored procedure 47 may produce raw data, or an instance of the data, that is transmitted back to the calling entity. Any stored procedure 47 may be developed that is appropriate for delivering a desired result. In this manner, a plurality of stored procedures may be developed, stored and called for execution a plurality of times as is appropriate for use with the number of allowable concurrent authorized end-users. The present invention may incorporate the use of a maintenance utility that creates all or portions of the instructions that form the stored procedure 47.

With reference to FIG. 3, the information server 33 may include an ASP engine 49 with Active Server Pages 51 that may be executed via the ASP engine 49. The Active Server Pages 51, referred to as ASP pages 51, may be one or more pages of code that comprise the controlling program that manages the interchange of data from the Client 23 with the Data Repository Data Object 60, or DRDO 60, which will be discussed subsequently. In this manner, when the Client 23 request access to the web-based application, the information server 33 engages the controlling ASP pages 51, which may execute and send back Client interface screen data to be viewed by the Client 23 for further interaction over the Network 21. While one embodiment of the present invention utilizes Active Server Pages 51 any type of dynamic web page software may be used with sound judgment as is appropriate for use with the present invention. In that dynamic web pages, Active Server Pages and related software are well known in the art, no further explanation will be offered at this time.

Modular programming is a modern programming paradigm that facilitates code re-use and expedites application development by breaking large programming projects solutions into distinct, simplified and smaller programs wherein the smaller programs may be used as modular building blocks by other programs. In other words, each modular program may be utilized independently of the larger application and may be integrated into other programming applications. One such implementation of a modular web-based application may utilize COM objects as mentioned above. The COM objects are known in the art to be a standard implementation of modular programming.

With continue reference to FIG. 3, there is provided a Data Repository Data Object 60, herein referred to as DRDO 60, which may reside in memory on the Server 18. The DRDO 60 may be COM object that may be called from a plurality of programs as is well known in the art for with modular programming and COM objects. In one embodiment, the controlling ASP pages 51 may make a call to the DRDO 60 responsive to a request by the end-user utilizing the Client computer 23. The DRDO 60 may function as a conversion module, which functions to receive data in XML, or a similar network-communication-language program, data from the controlling ASP pages 51. The DRDO 60 may receive the instructions from the controlling ASP pages 51 and associated data. Subsequently, the DRDO 60 may access the database server 44. What is particularly novel about the interaction of the DRDO 60 with the database server 44 is that the DRDO 60 may make requests to the database server 44 to engage Stored Procedures 47 that may reside in memory of the database server. This functions to transfer a substantial portion of processing resources onto the database server and away from the resources of the information server and the DRDO 60. Responsive to the request from the DRDO 60 to return data from the database server 44, information may be transferred back to the DRDO 60 in the form of raw data. The DRDO 60 may then process the raw data into an XML format. In this manner, database information may be changed into a form that is quickly deliverable to over the network, such as XML or another similar language. After the database information has been changed into XML, as in the preferred embodiment, the information is then processed by the ASP pages 51 or transmission back over the network to the Client computer 23.

In that the DRDO 60 may be a COM object, a plurality of COM objects, or DRDOs, may exists that are accessible by the controlling ASP pages 51. Each of the plurality of DRDO COM objects may be created specifically to access a specific stored procedure or stored procedures, located on the database server. In this way, a DRDO may exist that directly correlates to and/or utilizes one or more stored procedures. As the stored procedure 47′ executes, data may be returned via the calling DRDO 60′ for conversion into XML for the purpose of being transmitted back over the network 21 with the coordinating help of the information server 33. Code operatively contained within the ASP pages 51, which may be VBScripting, may be constructed in accordance with the web-based application, which calls the appropriate DRDO 60′ and which in turn accesses raw data in the database server as previously discussed. It should be noted that any ASP Page code and scripting algorithm may be chosen with sound engineering judgment as is appropriate for use a web-based application program.

With reference to FIG. 3, a Security module 70 may reside on the Server 18. In one embodiment, the Security module 70 may reside in the memory of the computer where the information server 33 is stored. The Security module 70 may be COM object that can be called from a plurality of programs and a plurality of times. The Security module 70 may receive at least a first user-verification request from one of the calling ASP Pages 51′, which may function as an interface between the Client 23 and the data on the Server 18 in a manner previously discussed. The calling ASP page 51′ may process a request by the Client 23, such as initial user-log in, by passing a user entered string to the Security module 70 for eligibility verification that the end-user may have access to the data. The string may be encrypted for use by the Security module 70. The encrypted string may include logon information such as the user name and the associated password associated with the name. Coordinating verification information may be stored within the database server 44 for comparison with the encrypted login information. This information may be appropriately entered by an associated database administrator and stored in the database upon initiating a new authorized user identity. The Security module 70, which may reside on the Server 18, may be source code that contains specific information about the location of the database server 44. This functions to serve as a highly affective security buffer against access by an unauthorized end-user or other such user. Upon properly verifying the user identity, the Security module 70 may approved the command request as determined by the calling ASP page 51′ for engagement of the appropriate DRDO 60′, which may in turn make a call to one or more stored procedures 47′ requesting the processing and return of database information. It is noted that since the Security module 70 is a COM object and may be called numerous times by various calling entities, increased security may be obtained by appropriately placing calls to the Security module 70 throughout the scripting on the dynamic web pages. In that, the Security module 70 alone has the access information for establishing a communicating link to the database server, bypassing the Security module 70 would prevent access to the database server 44 and its associated information. In this manner, the Security module 70 may be called any number of times and any location or calling program to verify user identity.

In this manner, selective information, delivered from the ASP pages 51 about the end-user identity, is communicated to the Security module 70, which may subsequently access or communicate to the database server 44 to establish what level of authority the end-user has to information stored in the database serve 44. It is noted that at any point in the code on the ASP pages 51, scripting contained therein or even from within DRDO, that the calling program entity may call out to the Security module to verify the level of authority that a particular end-user has in accessing certain information. In this way, security verification can be implemented at any desired location within the flow of information into and out of the Server 18. This creates a distinct advantage from present security paradigms in that security can be implement at various levels and places all while maintaining complete anonymity of the location of the database server.

The preferred embodiments have been described, hereinabove. It will be apparent to those skilled in the art that the above methods may incorporate changes and modifications without departing from the general scope of this invention. It is intended to include all such modifications and alterations in so far as they come within the scope of the appended claims or the equivalents thereof.

Having thus described the invention, it is now claimed:

I/We claim:

1. A computer implemented method for sending information over a computer network, the steps comprising:
providing an associated client computer and a server computer, wherein the associated client computer is operatively communicated to the server computer over a computer network;
providing an information server to control the flow of communication between the associated client computer and the server computer, wherein the information server resides on the server computer;
providing a database server including at least a first database table containing associated database information, wherein the database server controls the flow of data;
providing a translating COM object for use in interfacing between the associated client and the database server, wherein the translating COM object translates the associated database information for use in sending the translated associated database information over the computer network;
requesting associated database information by the client computer;
accessing the associated database information;
translating the associated database information; and,
sending the translated associated database information to the client computer over the computer network.

2. The method of claim 1, further comprising the steps of:
providing a dynamic web page program operatively residing on the information server, wherein the dynamic web page program controls the request for associated database information from the client computer, wherein the dynamic web page program makes calls to the translating COM object.

3. The method of claim 2, further comprising the steps of:
providing a security COM object for use in verifying an associated end-users identity.
